(19) United States
(12) Patent Application Publication
(10) Pub. No.: US 2023/0368145 A1
(43) Pub. Date: Nov. 16, 2023

(54) SYSTEM AND APPARATUSES TO MATCH EMPLOYEES WITH EMPLOYERS, AND A METHOD THEREOF

(71) Applicant: Semerey Dental Management, LLC, Columbia, MD (US)

(72) Inventor: Vladimir Semerey, Columbia, MD (US)

(73) Assignee: Semerey Dental Management, LLC, Columbia, MD (US)

(21) Appl. No.: 15/898,668

(22) Filed: Feb. 19, 2018

Related U.S. Application Data
(60) Provisional application No. 62/436,612, filed on Dec. 20, 2016.

(51) Int. Cl. G06Q 10/1053; G06Q 10/0631; G06Q 10/1093

(52) U.S. Cl. CPC G06Q 10/1053; G06Q 10/06312; G06Q 10/1097

(57) ABSTRACT

A system to provide employees to an employer, the system including a storage device to store selectable profiles of the employees, and an apparatus, including a processor to access at least one of the stored selectable profiles based on criteria specified by the employee, an input unit to allow the employer to select the at least one of the stored selectable profiles, a transceiver to transmit a request to at least one employee corresponding to the selected at least one selectable profile in response to the employer selecting the at least one selectable profile, and a receiver to receive a notification indicating that one of the employees has accepted the request.

### CROSS-REFERENCE TO RELATED APPLICATIONS

This application claims priority under 35 USC § 119(e) from U.S. Provisional Application No. 62/436,612, filed on Dec. 20, 2016, in the United Stated Patent and Trademark Office, the disclosure of which is incorporated herein in its entirety by reference.

### BACKGROUND

### 1. Field

The present general inventive concept relates to a system to match employees with employers based on criteria specified by the employers, apparatuses, and a method thereof.

### 2. Description of the Related Art

Employers (e.g., doctors, dentists, lawyers, accountants, administrators, store managers, business owners, restaurant owners, etc.) experience a daily challenge of ensuring that their businesses are fully staffed in order to ensure that the businesses run efficiently. Therefore, when an employee/staff member (e.g., secretaries, receptionists, office managers, nurses, dental hygienists, assistants, bartenders, wait-staff, bus-boys, contractors, etc.) is sick or decides to take a vacation, and therefore is absent from work, an employer must quickly replace the employee/staff member with a temporary employee/staff member.

Conventionally, staffing agencies are used to help employers find suitable temporary replacements for employees/staff members/personnel who are absent from work. However, an employer must typically pay a fee or percentage of the wage to the staffing agency every time the staffing agency provides a suitable temporary replacement to the employer. This can become costly and time consuming, especially if the temporary replacement does not provide the services required, and another temporary replacement is necessary. In other words, if the temporary replacement is not a good match for the employer, it is costly and time consuming to try to find a more suitable replacement.

Therefore, there is a need for a virtual employment/staffing web site and a virtual employment/staffing application to allow an employer to selectively choose suitable employee/staff replacements for a particular business, job, or task, based on particular needs and requirements of the employer.

Also, there is a need for a virtual employment/staffing web site and a virtual employment/staffing application to allow potential employees/staff members to quickly respond to a request from an employer to fill a spot for a particular business, job, or task, in real time.

Moreover, there is a need for a virtual employment/staffing web site and a virtual employment/staffing application that prevents employers from receiving an influx of notifications from a myriad of eager employees responding to multiple job requests from employers.

### SUMMARY

The present general inventive concept provides a system to match employees with employers based on criteria specified by the employers, apparatuses, and a method thereof.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a system to provide employees to an employer, the system including a storage device to store selectable profiles of the employees, and an apparatus, including a processor to access at least one of the stored selectable profiles based on criteria specified by the employee, an input unit to allow the employer to select the at least one of the stored selectable profiles, a transceiver to transmit a request to at least one employee corresponding to the selected at least one selectable profile in response to the employer selecting the at least one selectable profile, and a receiver to receive a notification indicating that one of the employees has accepted the request.

The foregoing and/or other features and utilities of the present general inventive concept may also be achieved by providing an apparatus to allow an employer to send a request to at least one employee, the apparatus including a processor to access at least one a plurality of selectable profiles stored on an outside storage device, based on criteria specified by an employer, an input unit to allow the employer to select the at least one of the stored selectable profiles, a transceiver to transmit a request to the at least one employee corresponding to the selected at least one selectable profile in response to the employer selecting the at least one selectable profile, and a receiver to receive a notification indicating that one of the employees has accepted the request.

The foregoing and/or other features and utilities of the present general inventive concept may also be achieved by providing an apparatus to allow an employee to respond to a request from an employer, the apparatus including an input device to allow the employee to create a profile, a receiver to receive the request from the employer in response to the profile matching criteria specified by the employer, a transceiver to send a notification to the employer that the request has been accepted by the employee in response to the employee inputting on the input device that the request has been accepted.

The foregoing and/or other features and utilities of the present general inventive concept may also be achieved by providing a method of providing employees to an employer, the method including storing selectable profiles of employees, accessing at least one of the selectable stored profiles based on criteria specified by an employer, transmitting a request to the at least one employee corresponding to the at least one selectable profile in response to the employer selecting the at least one selectable profile, and receiving a notification indicating that the at least one of the employees has accepted the request.

### BRIEF DESCRIPTION OF DRAWINGS

These and/or other features and utilities of the present general inventive concept will become apparent and more readily appreciated from the following description of the embodiments, taken in conjunction with the accompanying drawings of which:

FIG. 1 illustrates a system to provide employees to an employer, according to an exemplary embodiment of the present general inventive concept;

FIG. 2 illustrates an apparatus to allow an employer to send a request to at least one employee, according to another exemplary embodiment of the present general inventive concept;

FIG. 3 illustrates an apparatus to allow an employee to respond to a request from an employer, according to another exemplary embodiment of the present general inventive concept;

FIG. 4 illustrates a method of providing employees to an employer, according to another exemplary embodiment of the present general inventive concept;

FIG. 5A illustrates an example of a home page of the website and/or the application as displayed on the apparatus 120, according to an exemplary embodiment of the present general inventive concept;

FIG. 5B illustrates an example of an employer registration page of the website and/or the application as displayed on the apparatus 120, according to an exemplary embodiment of the present general inventive concept;

FIG. 5C illustrates an example of an employee registration page of the website and/or the application as displayed on the apparatus 120, according to an exemplary embodiment of the present general inventive concept;

FIGS. 5D through 5G illustrate examples of employee registration pages of the website and/or the application as displayed on the apparatus 120, according to exemplary embodiments of the present general inventive concept;

FIG. 5H illustrates a post-registration confirmation page of the website and/or the application as displayed on the apparatus 120, according to an exemplary embodiment of the present general inventive concept;

FIG. 6A illustrates a sign-in page of the website and/or the application as displayed on the apparatus 120, according to an exemplary embodiment of the present general inventive concept;

FIG. 6B illustrates a sign-in page of the website and/or the application as displayed on the apparatus 120, when a user has forgotten a password, according to an exemplary embodiment of the present general inventive concept;

FIG. 7A illustrates a search input page of the website and/or the application as displayed on the apparatus 120, according to an exemplary embodiment of the present general inventive concept;

FIG. 7B illustrates the search input page of the website and/or the application as displayed on the apparatus 120, as illustrated in FIG. 7A, including comments, according to an exemplary embodiment of the present general inventive concept;

FIG. 8 illustrates a search result page of the website and/or the application as displayed on the apparatus 120, according to an exemplary embodiment of the present general inventive concept;

FIG. 9A illustrates a send request box of the website and/or the application as displayed on the apparatus 120 in response to the employer sending a request to a particular employee, according to an exemplary embodiment of the present general inventive concept;

FIG. 9B illustrates the send request box of the website and/or the application as displayed on the apparatus 120 in response to the employer sending a request to a particular employee, as illustrated in FIG. 9A, including comments, according to an exemplary embodiment of the present general inventive concept; and

FIGS. 10A through 10E illustrate examples of screen shots of the website and/or the application as displayed on the apparatus 120 and/or the apparatus 130, according to exemplary embodiments of the present general inventive concept.

### DETAILED DESCRIPTION

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

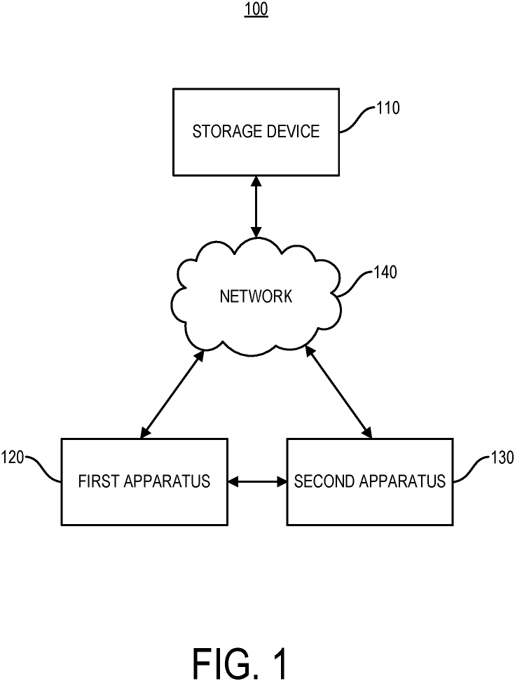

FIG. 1 illustrates a system 100 to provide employees to an employer, according to an exemplary embodiment of the present general inventive concept.

The system 100 may include a storage device 110, a first apparatus 120, a second apparatus 130, and a network 140, but is not limited thereto.

The storage device 110 may include a server, a computing device with a storage unit, and a cloud-based storage space, but is not limited thereto. The storage device 110 may store at least one of registration information of employers, registration information of employees, profiles of employers, profiles of employees, resumes, files, requests, request acceptances, programs, application data, code, and any other information pertaining to business and personnel data.

The first apparatus 120 may include a computing device that may receive input, transmit data, access the Internet, provide global positioning services (GPS), and communicate with other devices or systems via a network, and may include a desktop computer, a laptop computer, a tablet computer, or a mobile device, such as a cellular phone or a smart phone, but is not limited thereto.

The first apparatus 120 may access the Internet to allow the employer to access a website to find employees. The first apparatus 120 may also have stored thereupon a software application that allows the employer to find employees corresponding to criteria specified by the employer.

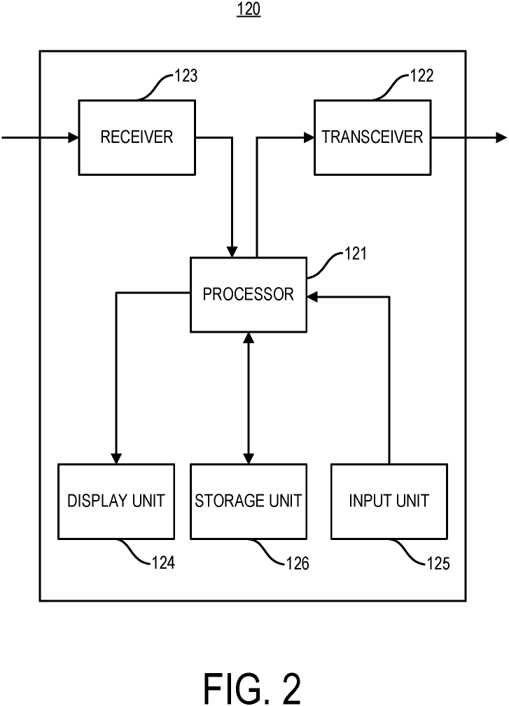

Referring to FIGS. 1 and 2, the first apparatus 120 may include a processor 121, a transceiver 122, a receiver, 123, a display unit 124, an input unit 125, and a storage unit 126, but is not limited thereto.

The processor 121 may execute wiring, components, programs, code, and/or applications that allow the first apparatus 120 to access the website and/or the applications to allow the employer to search for employees. Also, the processor 121 may include wiring, components, programs, code, and/or applications that allow the first apparatus 120 to access the website and/or the applications to allow the employee to respond to job requests from the employer.

The transceiver 122 may allow the first apparatus 120 to communicate with the storage unit 110, to send information to the storage unit 110.

The receiver 123 may allow the first apparatus 120 to communicate with the storage unit 110, to receive information from the storage unit 110.

The display unit 124 may allow webpages, objects, graphics, and data to be displayed thereupon visually or audibly for a user.

The input unit 125 may allow the user to input data into the apparatus 120. The input unit 125 may include a keyboard, a touch screen, a trackball, a touch pad, a mouse, a voice command input device, etc., but is not limited thereto.

The storage unit 126 may store information regarding the employer and/or the employee, as well as software corresponding to the website and/or the application. The storage unit 126 may be a non-transitory computer readable medium, flash memory, a magnetic disk drive, an optical drive, a programmable read-only memory (PROM), a read-only memory (ROM), or any other memory or combination of memories. The software can run on the processor 121, which is capable of executing computer instructions or computer code. The processor 121 may also be implemented in hardware using an application specific integrated circuit (ASIC), programmable logic array (PLA), field programmable gate array (FPGA), or any other integrated circuit.

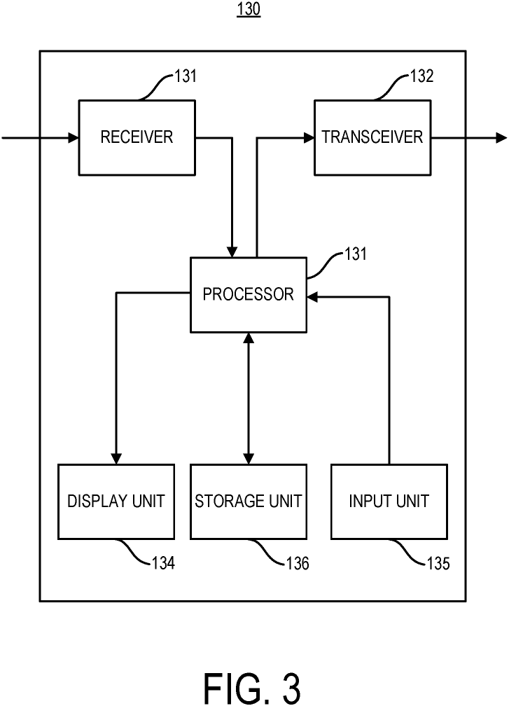

Referring to FIG. 3, the second apparatus 130 may be a computing device that may receive input, transmit data, access the Internet, provide global positioning services (GPS), and communicate with other devices or systems via a network, and may include a desktop computer, a laptop computer, a tablet computer, or a mobile device, such as a cellular phone or a smart phone, but is not limited thereto.

The second apparatus 130 may access the Internet to allow an employee to receive a request from the employer for a particular job, task, or assignment, based on a profile of the employee matching the criteria requested by the employer. The second apparatus 130 may also have stored thereupon a software application to allow the employee to receive a request from the employer for a particular job, task, or assignment, based on a profile of the employee matching the criteria requested by the employer.

Referring to FIGS. 1 and 3, the first apparatus 130 may include a processor 131, a transceiver 132, a receiver, 133, a display unit 134, an input unit 135, and a storage unit 136, but is not limited thereto.

The processor 131 may execute wiring, components, programs, code, and/or applications that allow the first apparatus 130 to access the website and/or the applications to allow the employer to search for employees. Also, the processor 131 may include wiring, components, programs, code, and/or applications that allow the first apparatus 130 to access the website and/or the applications to allow the employee to respond to job requests from the employer.

The transceiver 132 may allow the first apparatus 130 to communicate with the storage unit 110, to send information to the storage unit 110.

The receiver 133 may allow the first apparatus 130 to communicate with the storage unit 110, to receive information from the storage unit 110.

The display unit 134 may allow webpages, objects, graphics, and data to be displayed thereupon visually or audibly for a user.

The input unit 135 may allow the user to input data into the apparatus 130. The input unit 135 may include a keyboard, a touch screen, a trackball, a touch pad, a mouse, a voice command input device, etc., but is not limited thereto.

The storage unit 136 may store information regarding the employer and/or the employee, as well as software corresponding to the website and/or the application. The storage unit 136 may be a non-transitory computer readable medium, flash memory, a magnetic disk drive, an optical drive, a programmable read-only memory (PROM), a read-only memory (ROM), or any other memory or combination of memories. The software can run on the processor 131, which is capable of executing computer instructions or computer code. The processor 131 may also be implemented in hardware using an application specific integrated circuit (ASIC), programmable logic array (PLA), field programmable gate array (FPGA), or any other integrated circuit.

The second apparatus 130 is not required, and the website and the software application may be accessed by the first apparatus 120 to perform functions of both the first apparatus 120 and the second apparatus 130.

Referring to FIG. 1, the network 140 may be at least one of the Internet, a cellular network, a universal mobile telecommunications systems (UMTS) network, a Long Term Evolution (LTE) network, a Global System for Mobile Communications (GSM) network, a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. The network 140 can be implemented with any number of hardware and software components, transmission media, and network protocols. FIG. 1 illustrates the network 140 as a single network, but is not limited thereto.

The first apparatus 120 and the second apparatus 130 can both can send data to, and receive data from, the storage device 110 over via the Internet or any of the above-mentioned networks. The first apparatus 120 and the second apparatus 130 can be directly coupled to the storage device 110. Alternatively, the first apparatus 120 and the second apparatus 130 can be connected to the storage device 110 via any other suitable device, communication network, or combination thereof. For example, the first apparatus 120 can be coupled to the storage device 110 via routers, switches, access points, and/or communication networks. In other words, the storage device 110, the apparatus 120, and the apparatus 130 may all communicate with each other via the network 140.

Referring to FIG. 1, when an employer needs to hire a temporary employee for a particular time period at a specified salary, such that the temporary employee possesses particular characteristics, background, and/or skills, the employer may use the apparatus 120 to either access the website or the application to perform a search for employees having specified criteria. More specifically, the employer may use the apparatus 120 to access the website or the application to search for employees that have: (1) availability from Jan. 1, 2017 to Jan. 10, 2017, (2) a wage requirement of $50/hour, (3) a license to be dental hygienists, and/or (4) are located within 20 miles of the employer’s office. When the employer conducts a search based on the above specified criteria, the apparatus 120 accesses the storage unit 110, which returns a list of stored potential employees with profiles corresponding to the specified criteria to the apparatus 120. The apparatus 120 then displays the list of employees and/or profiles of the potential employees, such that the employer may select at least one of the potential employees. In response to the employer’s selection of at least one of the potential employees, the apparatus 120 transmits a request to the storage unit 110, which then sends the request to the selected employees. The employee can use the apparatus 130 (or the apparatus 120), in order to accept the request. When the employee accepts the request, then the storage unit 110 may automatically send a notification to other employees selected by the employer, that the request has been withdrawn (i.e., a potential job position is no longer available).

The storage device 110 may intermediate communication between employers and potential employees operating the apparatuses 120 and 130, respectively. The storage device 110 may operate using an operating system (OS) software. In some embodiments, the OS software is based on a Linux software kernel and runs specific applications in the server such as monitoring tasks and providing protocol stacks. The OS software can allow server resources to be allocated separately for control and data paths. For example, certain packet accelerator cards and packet services cards can be dedicated to performing routing or security control functions, while other packet accelerator cards/packet services cards can be dedicated to processing user session traffic. As network requirements change, hardware resources can be dynamically deployed to meet the requirements in some embodiments.

The software of the storage device 110 can be divided into a series of tasks that perform specific functions. These tasks communicate with each other as needed to share control and data information throughout the storage device 110. A task can be a software process that performs a specific function related to system control or session processing. Three types of tasks operate within the server 104 in some embodiments: critical tasks, controller tasks, and manager tasks. The critical tasks control functions that relate to the server’s ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem can include critical tasks, controller tasks, and manager tasks. Some of the subsystems that run on the storage device 110 include a system initiation task subsystem, a high availability task subsystem, a shared configuration task subsystem, and a resource management subsystem.

The system initiation task subsystem can be responsible for starting a set of initial tasks at system startup and providing individual tasks as needed. The high availability task subsystem works in conjunction with the recovery control task subsystem to maintain the operational state of the storage device 110 by monitoring the various software and hardware components of the storage device 110. The recovery control task subsystem can be responsible for executing a recovery action for failures that occur in the storage device 110 and receives recovery actions from the high availability task subsystem. Processing tasks can be distributed into multiple instances running in parallel so that if an unrecoverable software fault occurs, the entire processing capabilities for that task are not lost. User session processes can be sub-grouped into collections of sessions so that if a problem is encountered in one sub-group users in another sub-group will not be affected by that problem.

The shared configuration task subsystem can provide the storage device 110 with an ability to set, retrieve, and receive notification of server configuration parameter changes and is responsible for storing configuration data for the applications running within the storage device 110. The resource management subsystem can be responsible for assigning resources (e.g., processor and memory capabilities) to tasks and for monitoring the task’s use of the resources.

In some embodiments, the storage device 110 can reside in a data center and form a node in a cloud computing infrastructure. The storage device 110 can also provide services on demand. A module hosting a computing device is capable of migrating from one server to another server seamlessly, without causing program faults or system breakdown. The storage device 110 on the cloud can be managed using a management system.

According to FIG. 1, the storage device 110 can maintain information about employers and employees that access and/or register on the website or the application. The information in the storage device 110 can be configured or accessed via the website and/or the application.

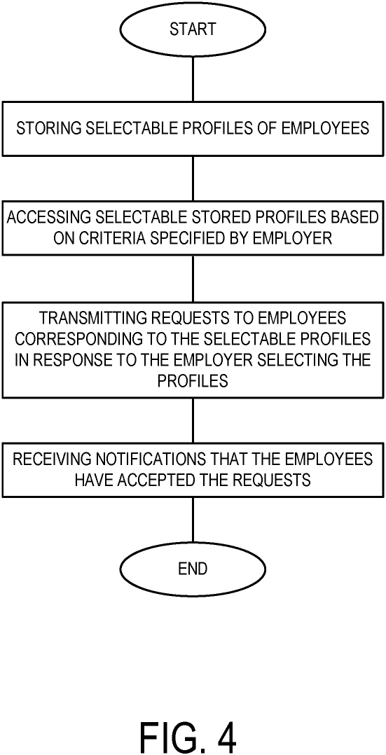

FIG. 4 illustrates a method of providing employees to an employer, according to another exemplary embodiment of the present general inventive concept.

Referring to FIG. 4, operation S410 may include storing selectable profiles of employees. Operation S420 may include accessing at least one of the selectable stored profiles based on criteria specified by an employer. Operation S430 may include transmitting a request to the at least one employee corresponding to the at least one selectable profile in response to the employer selecting the at least one selectable profile. Operation S440 may include receiving a notification indicating that the at least one of the employees has accepted the request. Other operations may include displaying data, sending notifications between various apparatus, and closing out job requests.

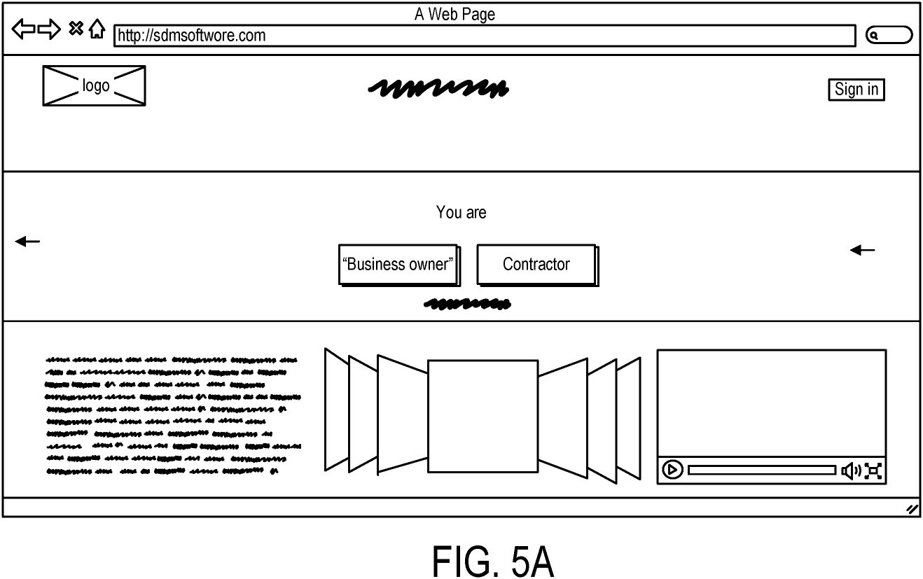

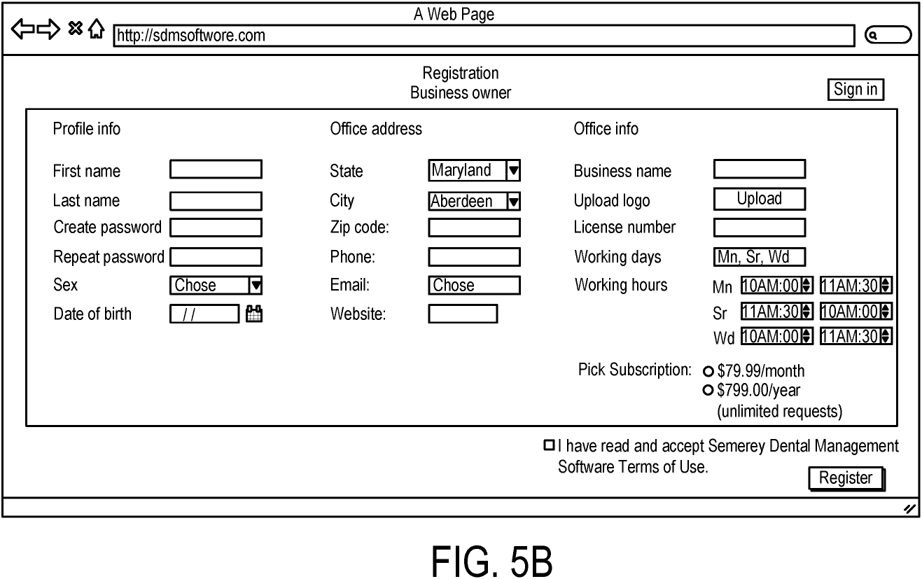

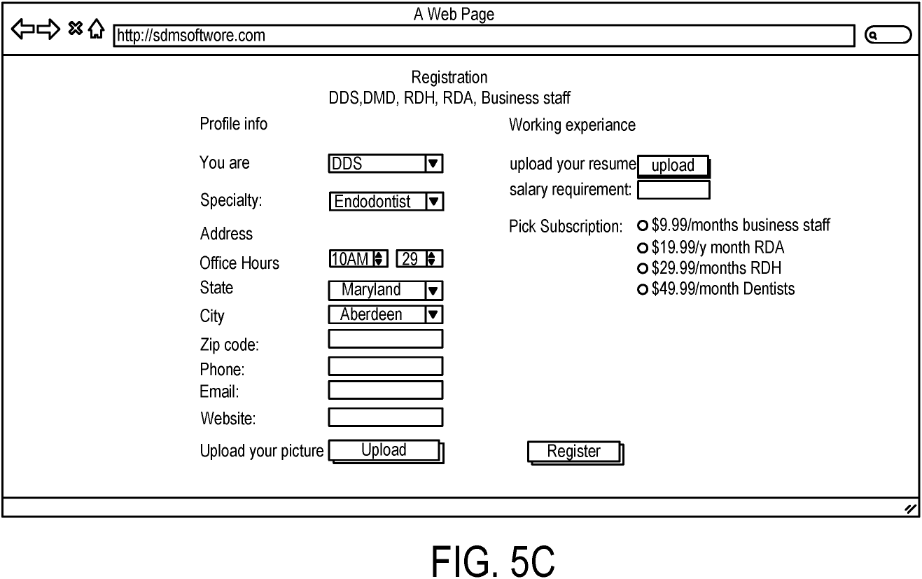

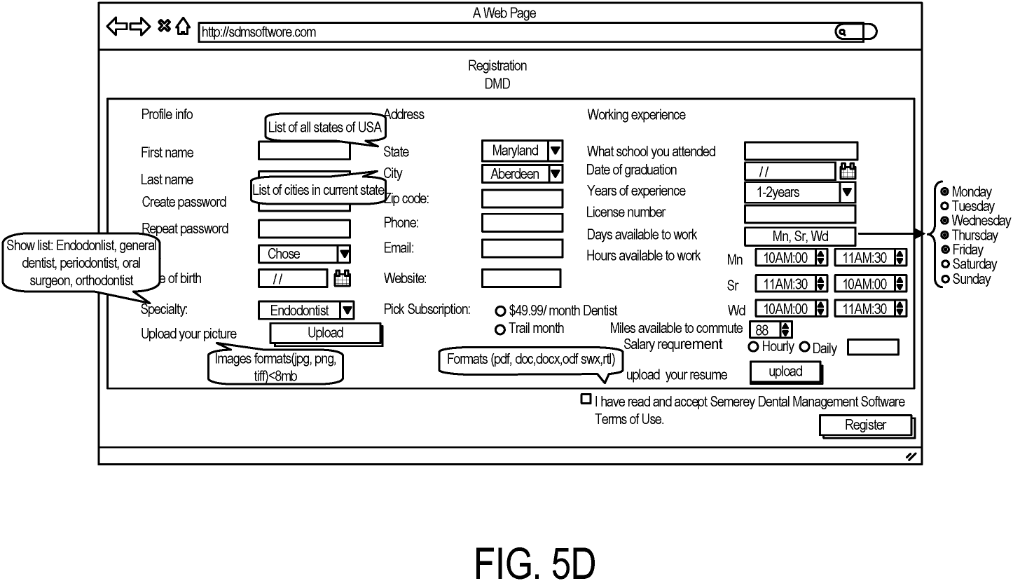

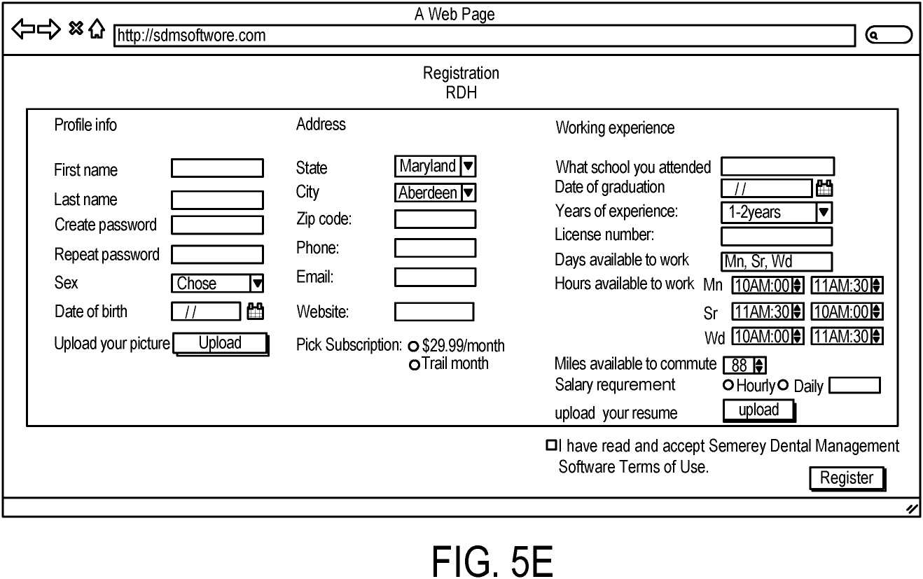

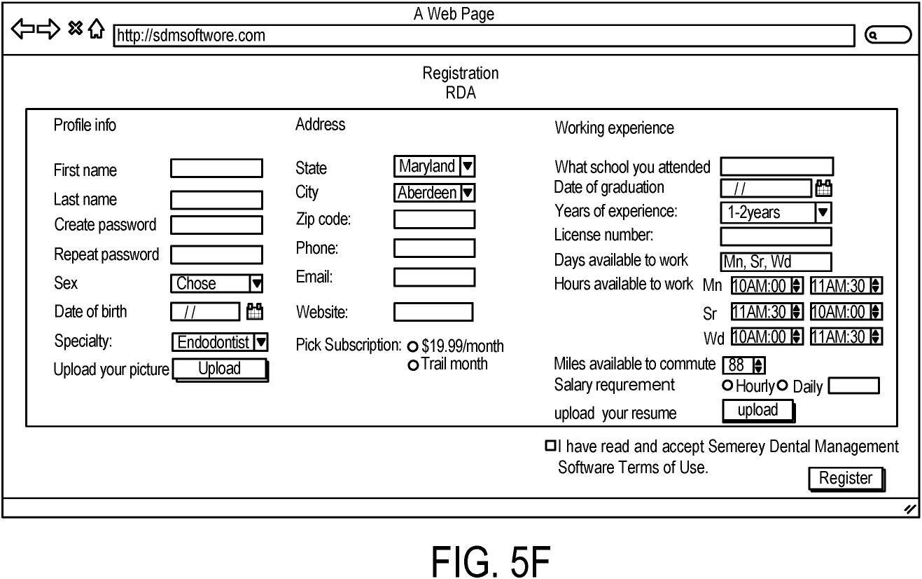

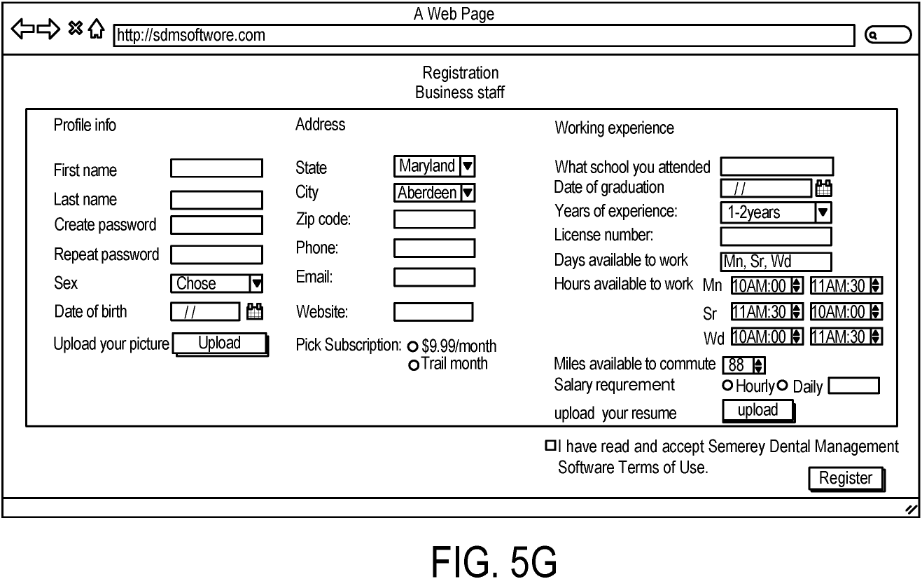

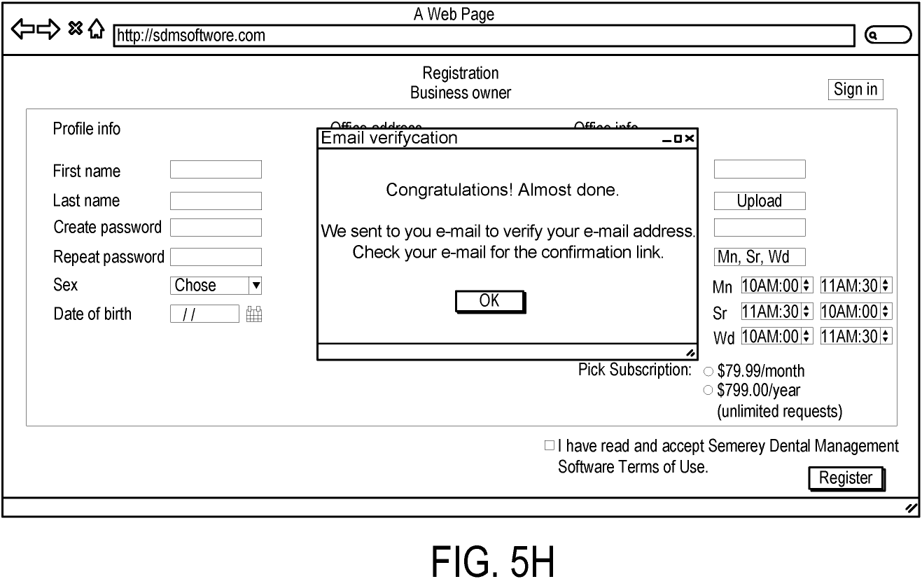

FIG. 5A illustrates an example of a home page of the website and/or the application as displayed on the apparatus 120, according to an exemplary embodiment of the present general inventive concept.

Referring to FIG. 5A, the home page may include an option to register as an employer or an employee, or alternatively, may include a sign in option for registered employers and/or employees. The website and/or the application may include two implementations, but is not limited thereto. A first exemplary implementation of the website and/or the application may be directed to use by an employer. A second exemplary implementation of the website and/or the application may be directed to use by an employee. More specifically, after a user chooses whether he/she is an employer or an employee, the user may input a user name and a password to begin registration. Alternatively, when the user selects whether he/she is an employer or an employee, the website and/or the application may direct the user to a registration page, as illustrated in FIGS. 5B through 5G, as described below.

FIG. 5B illustrates an example of an employer registration page of the website and/or the application as displayed on the apparatus 120, according to an exemplary embodiment of the present general inventive concept.

Referring to FIG. 5B, the aforementioned first exemplary implementation of the website and/or the application may provide the employer with a variety of options and functionalities. For example, the website and/or the application may allow the employer to register on the website and/or the application by creating a profile by inputting information including, but not limited to: (1) a first name of the employer, (2) a last name of the employer, (3) a password, (4) a verification of the password, (5) a gender of the employer, (6) a date of birth of the employer, (7) a state where a business of the employer is located, (8) a city where the business of the employer is located, (9) a zip code where the business of the employer is located, (10) a contact phone number of the employer, (11) an email of the employer, (12) a website address associated with the business, (13) a name of the business, (14) a license number of the employer, and (15) office hours and/or days that the business is open. Also, the registration of the employer may include options to: (1) upload a logo, (2) upload a picture, (3) upload a resume/curriculum vitae, and (4) choose a subscription duration/payment amount to have access to the website and/or the application.

FIG. 5C illustrates an example of an employee registration page of the website and/or the application as displayed on the apparatus 120, according to an exemplary embodiment of the present general inventive concept.

Referring to FIG. 5C, the aforementioned second exemplary implementation of the website and/or the application may provide the employee with a variety of options and functionalities. For example, the website and/or the application may allow the employee to register on the website and/or the application by creating a profile by inputting information including, but not limited to: (1) a title of the employee, (2) a specialty of the employee, (3) office hours of the employee, (4) a state where the employee is located, (5) a city where the employee is located, (6) a zip code where the business of the employee is located, (7) a contact phone number of the employee, (8) an email of the employee, and (9) a website address of the employee. Also, the registration of the employer may include options to: (1) upload a logo, (2) upload a picture, (3) upload a resume/curriculum vitae, (4) input salary/wage requirements, and (5) choose a subscription duration/payment amount to have access to the website and/or the application. Also, after the employer inputs the required information into fields displayed on the webpage and/or the application, the employer may be directed to another page to complete the registration process, such as a payment page to input payment information, including credit card information, bank account information, check information, and/or PAYPAL information.

FIGS. 5D through 5G illustrate examples of employee registration pages of the website and/or the application as displayed on the apparatus 120, according to exemplary embodiments of the present general inventive concept.

Referring to FIGS. 5D through 5G, the aforementioned second exemplary implementation of the website and/or the application may provide the employee with a variety of options and functionalities, based on a type of worker the employee is, or what type of title the employee possesses. For example, the website and/or the application may allow the employee to register on the website and/or the application by creating a profile by inputting information including, but not limited to: (1) a first name of the employee, (2) a last name of the employee, (3) a password, (4) a verification of the password, (5) a gender of the employee, (6) a date of birth of the employee, (7) a specialty of the employee, (8) a state where a the employee is located, (9) a city where the employee is located, (10) a zip code where the employee is located, (11) a contact phone number of the employee, (12) an email of the employee, (13) a website address associated with the employee, (14) a name of a school attended by the employee, (15) a year of graduation of the employee, (16) years of work experience of the employee, (16) a license number of the employee, (17) days of availability of the employee, (18) hours of availability of the employee, (19) miles available to commute of the employee, and (20) salary requirements of the employee. Also, the registration of the employer may include options to: (1) upload a logo, (2) upload a picture, (3) upload a resume/curriculum vitae, and (4) choose a subscription duration/payment amount to have access to the website and/or the application. Also, after the employee inputs the required information into fields displayed on the webpage and/or the application, the employee may be directed to another page to complete the registration process, such as a payment page to input payment information, including credit card information, bank account information, check information, and/or PAYPAL information.

FIG. 5H illustrates a post-registration confirmation page of the website and/or the application as displayed on the apparatus 120, according to an exemplary embodiment of the present general inventive concept.

Referring to FIG. 5H, when the employer or the employee finishes the registration process according to exemplary input fields illustrated in FIGS. 5B through 5G, the post-registration confirmation page of the website and/or the application may be displayed on the apparatus 120, and an email with a confirmation link may be automatically sent to the employer’s email or the employee’s email.

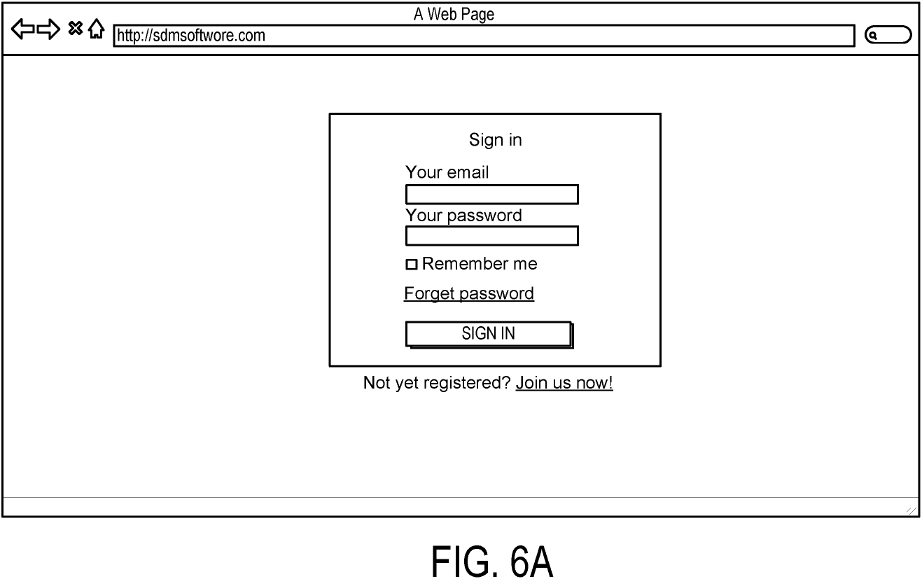

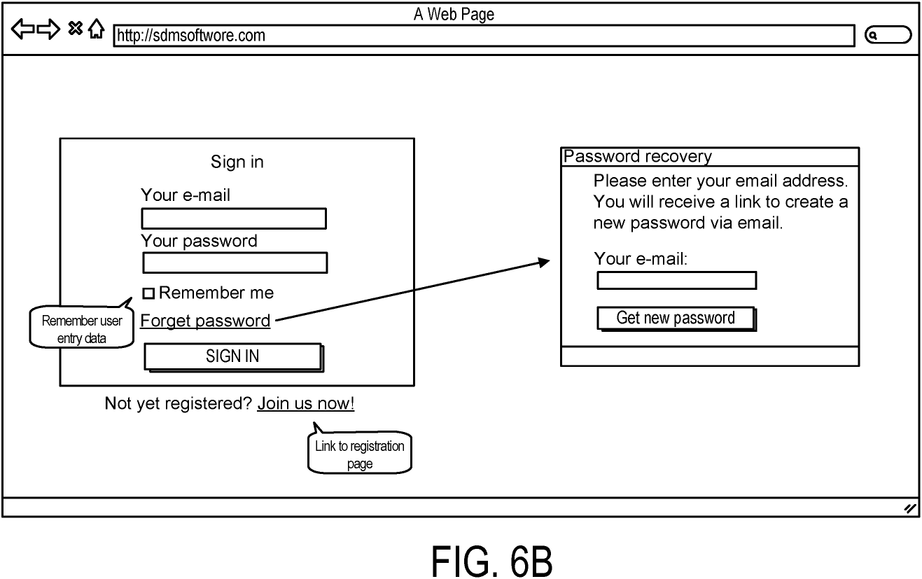

FIG. 6A illustrates a sign-in page of the website and/or the application as displayed on the apparatus 120, according to an exemplary embodiment of the present general inventive concept.

FIG. 6B illustrates a sign-in page of the website and/or the application as displayed on the apparatus 120, when a user has forgotten a password, according to an exemplary embodiment of the present general inventive concept.

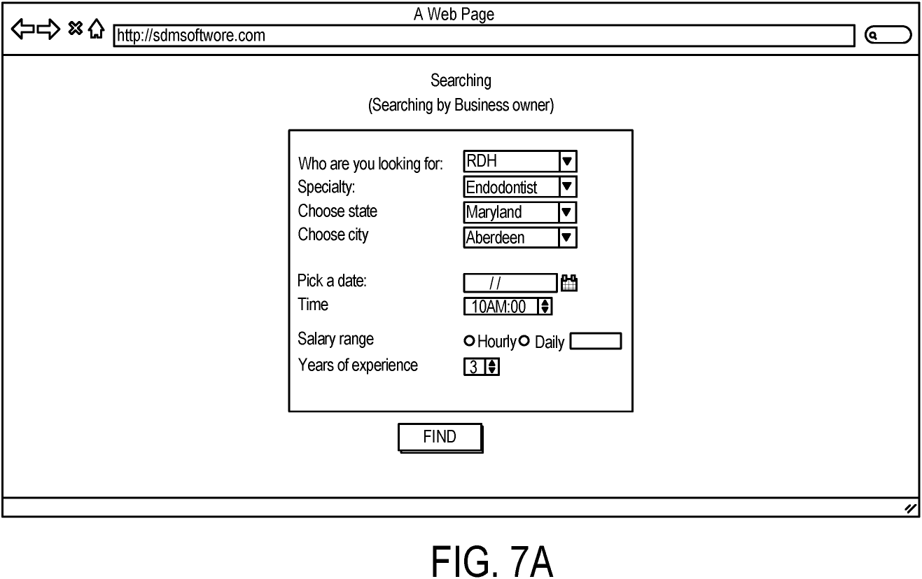

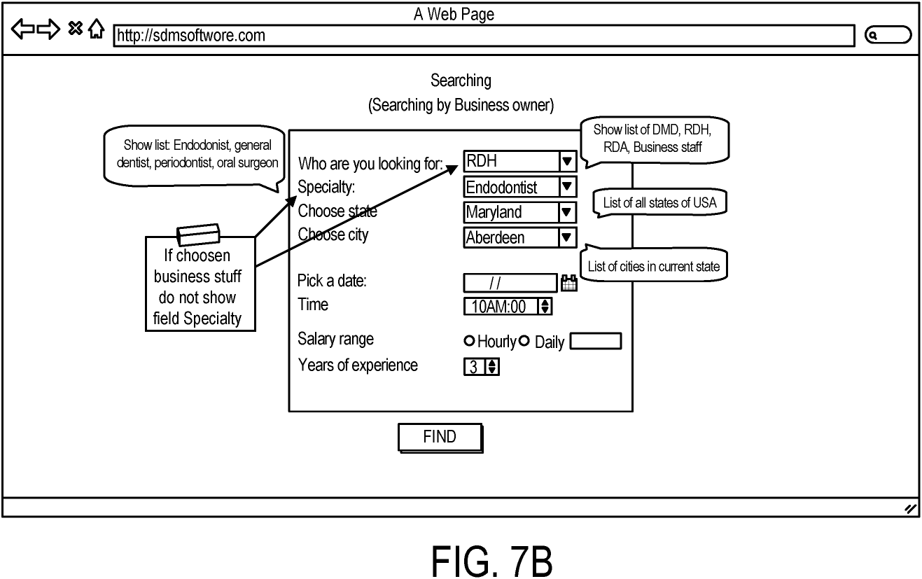

FIG. 7A illustrates a search input page of the website and/or the application as displayed on the apparatus 120, according to an exemplary embodiment of the present general inventive concept.

Referring to FIG. 7A, the employer may input various criteria in order to perform a search to find employees that match the preferences and/or requirements of the employer. For example, the website and/or the application may allow the employer to search for employees possessing criteria including, but not limited to: (1) a title of the employee, (2) a specialty of the employee, (3) a state where the business is located, (4) a city where the business is located, (5) a date that employment is requested, (6) a time that employment is requested, (7) a salary/wage range, and (8) years of experience of the employee.

FIG. 7B illustrates the search input page of the website and/or the application as displayed on the apparatus 120, as illustrated in FIG. 7A, including comments, according to an exemplary embodiment of the present general inventive concept.

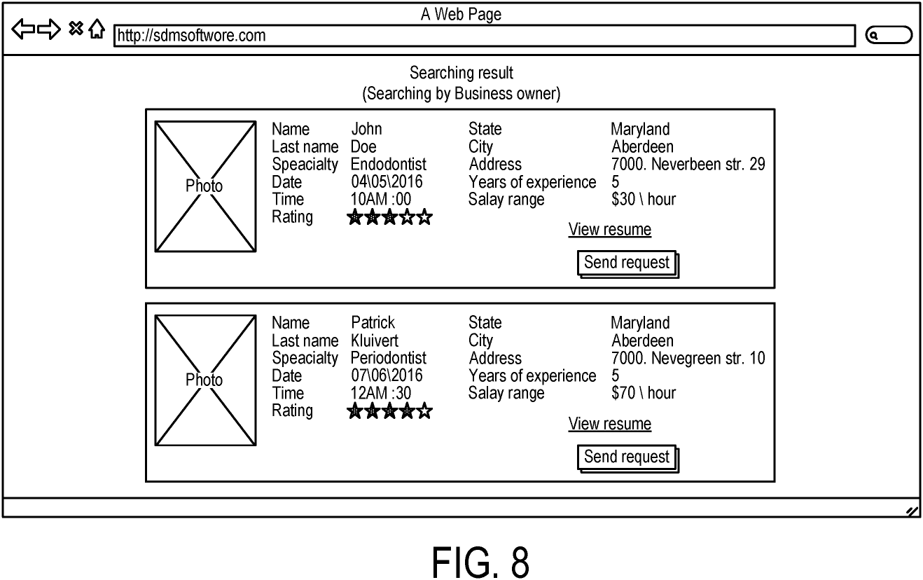

FIG. 8 illustrates a search result page of the website and/or the application as displayed on the apparatus 120, according to an exemplary embodiment of the present general inventive concept.

Referring to FIG. 8, after the employer fills in the required information in the search input page of FIG. 7A, any and all employees having profiles matching the search requirements input by the employer may be returned from the storage device 110 and displayed on the apparatus 120 for the employer to view. As such, the employer may select at least one employee from the search results page as illustrated in FIG. 8, which matches the employer’s preferences and requirements. More specifically, the employer may specify that multiple employees having same or differing criteria are requested, in order to facilitate a hiring process of the employer. As such, the employer may request that two or more employees respond to a same request if the criteria specified by the employer is the same for the two or more employees. Alternatively, the employer may make multiple requests if the criteria specified by the employer is different for the two or more employees. Also, the employer may view and/or download resumes and curriculum vitae from the search result page of FIG. 8.

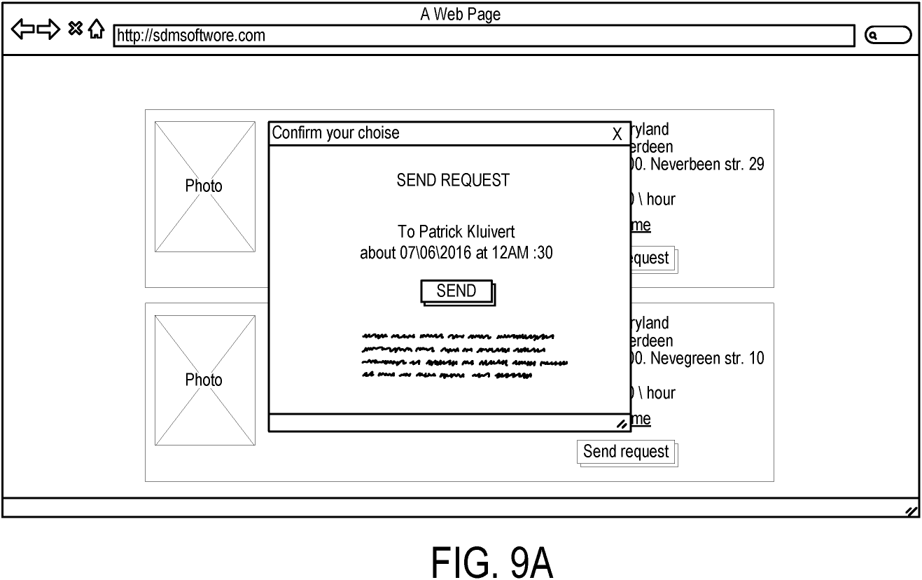

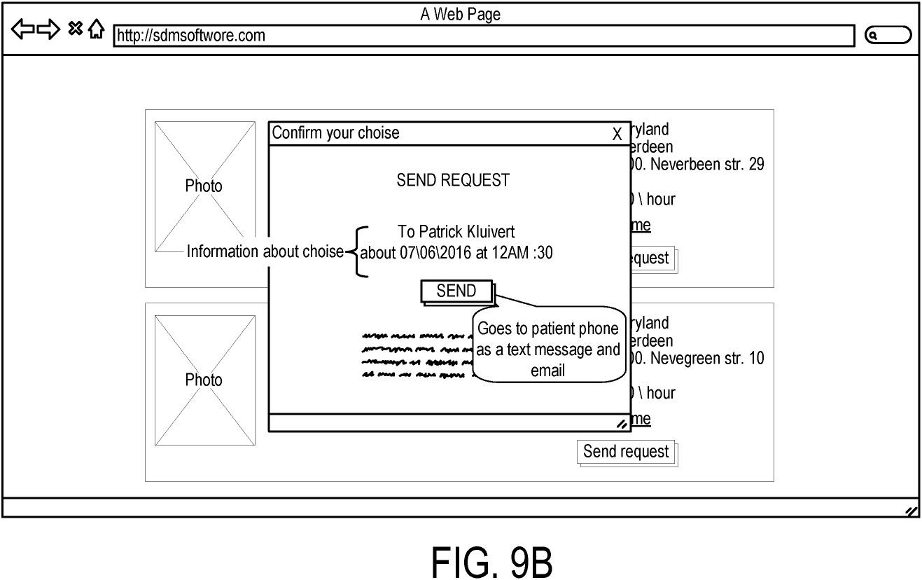

FIG. 9A illustrates a send request box of the website and/or the application as displayed on the apparatus 120 in response to the employer sending a request to a particular employee, according to an exemplary embodiment of the present general inventive concept.

Referring to FIG. 9A, the send request box is displayed on the apparatus 120 when the employer selects a particular employee from the search result page of FIG. 8. When the employer confirms the send request, the selected employee is notified via email, text message, and/or telephone call (i.e., having an automated message), that the employee has been selected for the employer’s particular job. The employee may receive the request on the apparatus 130, and may use the apparatus 130 to accept the request. Once the request is accepted by the employee, a notification is sent to the employer that the request has been accepted, and notifications may be sent to the other employees to whom the employer sent requests, in order to inform the other employees that the request has been filled. More specifically, in order to maintain real-time notification of job availability and employee acceptance, the present general inventive concept may send notifications via email, text message, or telephone call, in order to immediately and automatically inform employees that a job request has been filled.

FIG. 9B illustrates the send request box of the website and/or the application as displayed on the apparatus 120 in response to the employer sending a request to a particular employee, as illustrated in FIG. 9A, including comments, according to an exemplary embodiment of the present general inventive concept.

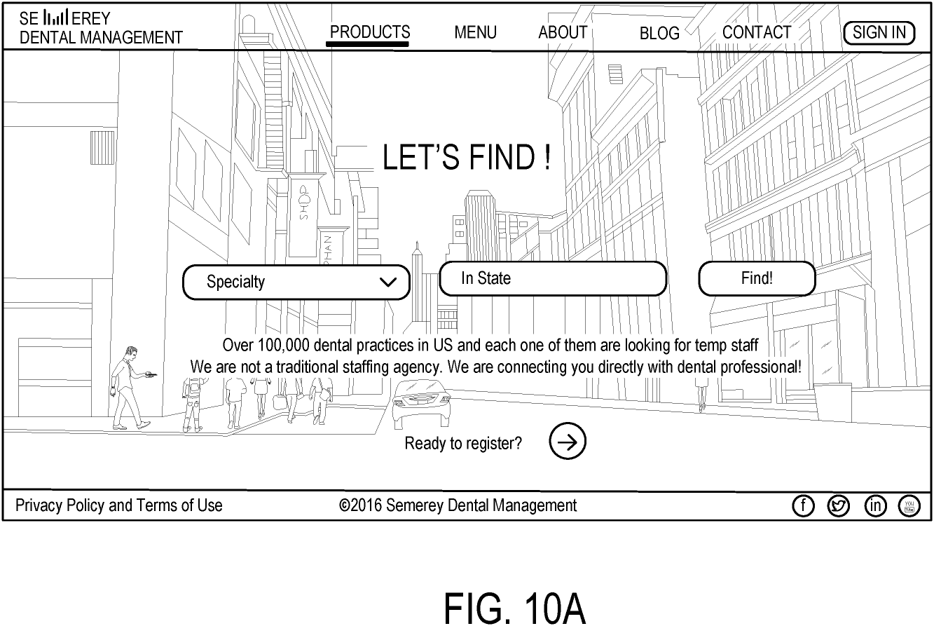

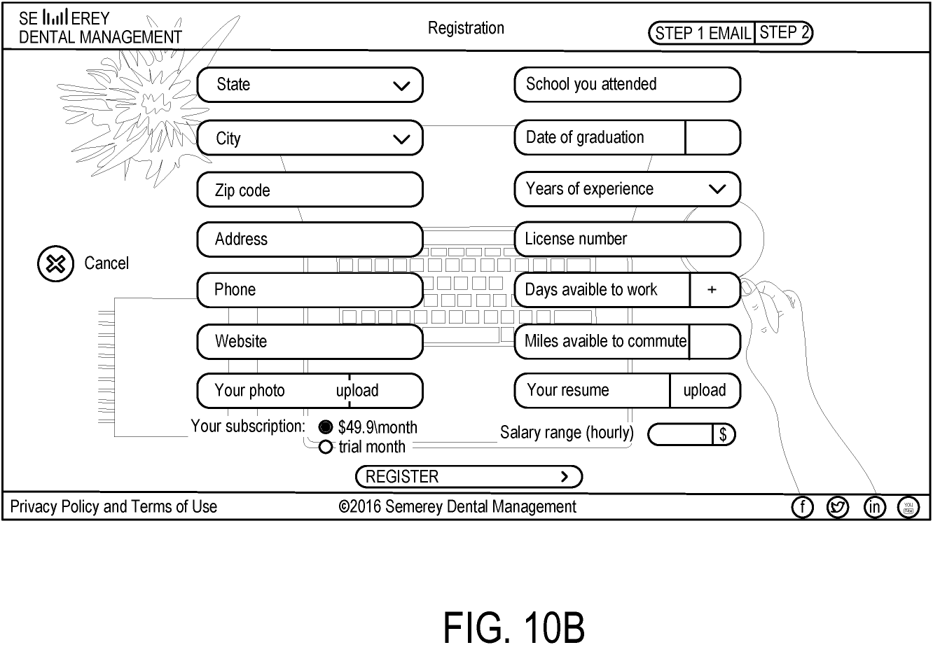

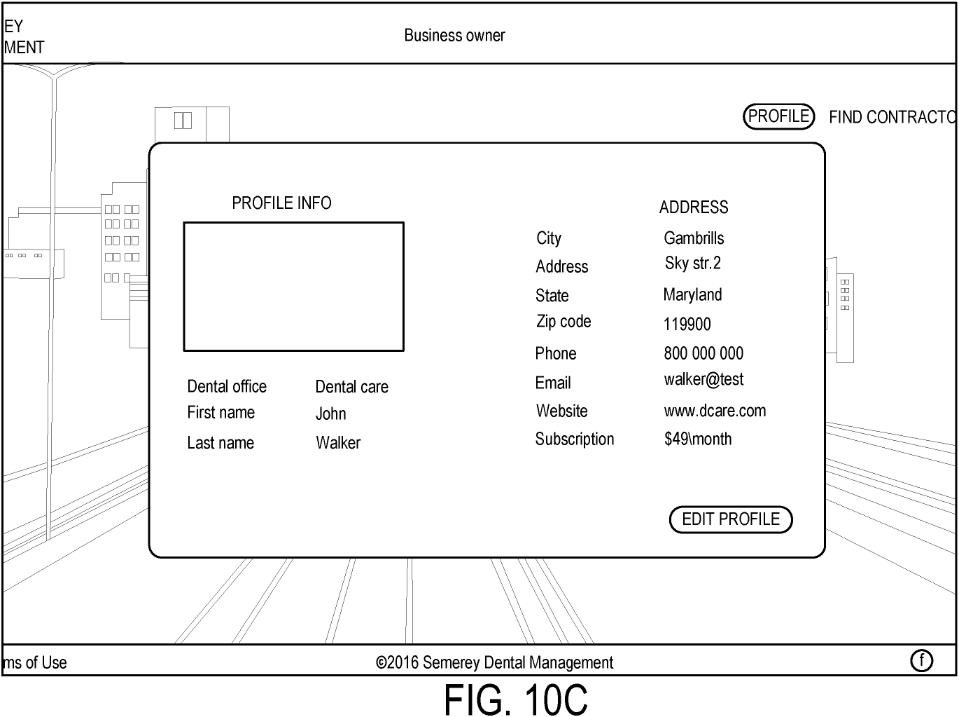

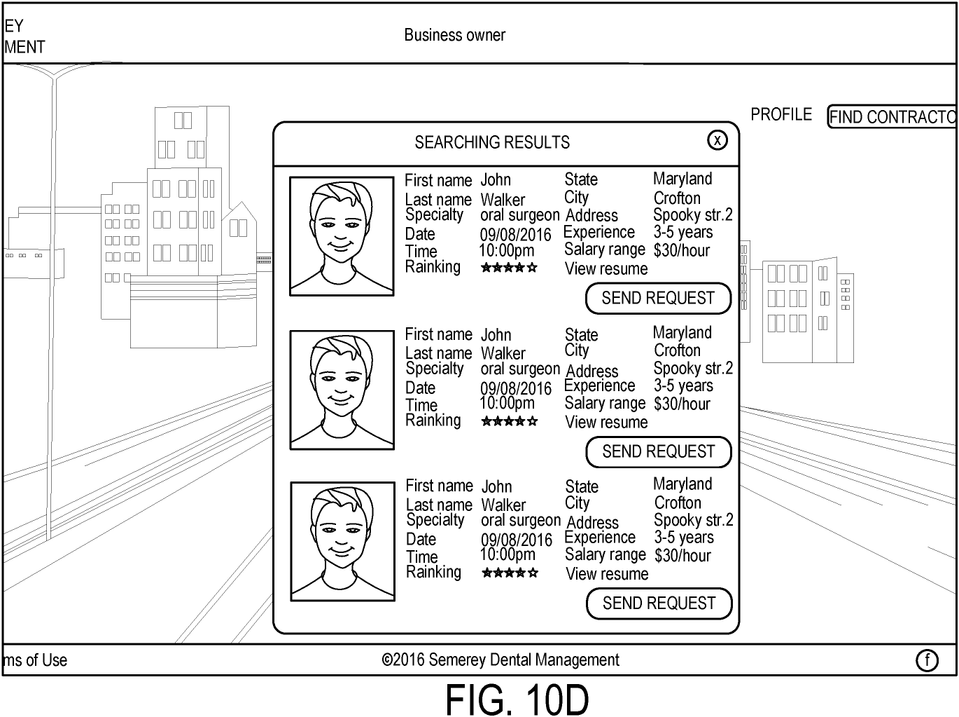

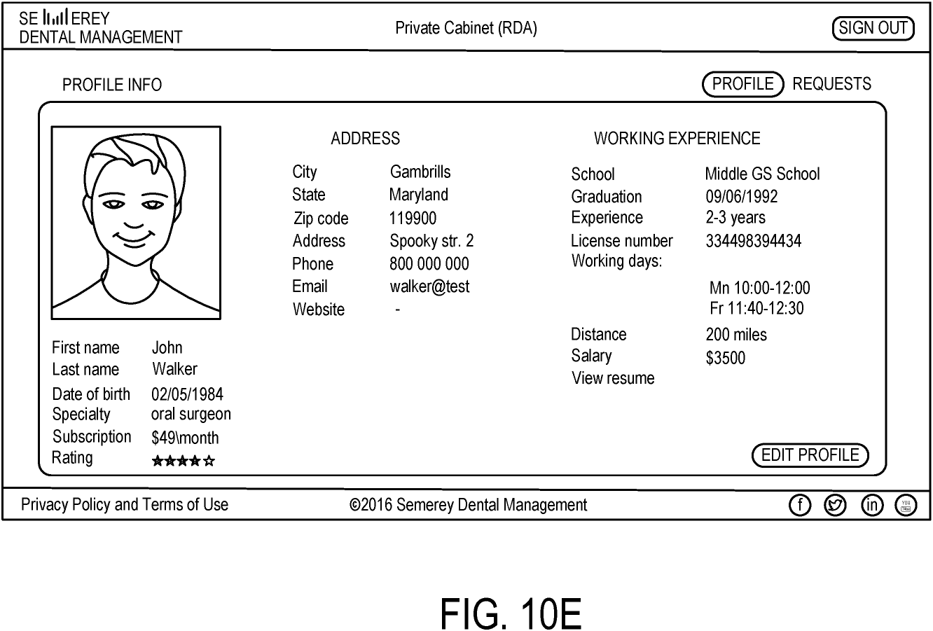

FIGS. 10A through 10E illustrate examples of screen shots of the website and/or the application as displayed on the apparatus 120 and/or the apparatus 130, according to exemplary embodiments of the present general inventive concept.

The present general inventive concept is directed to a system to allow an employer to hire temporary employees, or even permanent employees for that matter, by searching for the temporary or permanent employees using various criteria that is important to the employer. A list of employees matching the criteria is returned and displayed for the employer, and the employer may select the employee that best matches the employer’s needs. For example, a particular employee may have a more suitable resume than another employee, even though both employees came up in the search results. Then the employer can send requests to employees he/she desires to hire. The selected employees are then notified that they have received a request from an employer, and then can send a confirmation of acceptance of the job request.

The present general inventive concept may be applied to employers such as dentists, doctors, lawyers, accountants, store owners, business owners, etc., but is not limited thereto.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A system to provide employees to an employer, the system comprising:
a storage device to store selectable profiles of the employees; and
an apparatus, comprising:
a processor to access at least one of the stored selectable profiles based on criteria specified by the employer;
an input unit to allow the employer to select the at least one of the stored selectable profiles;
a transceiver to transmit a request to at least one employee corresponding to the selected at least one selectable profile in response to the employer selecting the at least one selectable profile; and
a receiver to receive a notification indicating that one of the employees has accepted the request.

2. An apparatus to allow an employer to send a request to at least one employee, the apparatus comprising:
a processor to access at least one a plurality of selectable profiles stored on an outside storage device, based on criteria specified by an employer;
an input unit to allow the employer to select the at least one of the stored selectable profiles;
a transceiver to transmit a request to the at least one employee corresponding to the selected at least one selectable profile in response to the employer selecting the at least one selectable profile; and
a receiver to receive a notification indicating that one of the employees has accepted the request.

3. An apparatus to allow an employee to respond to a request from an employer, the apparatus comprising:
an input device to allow the employee to create a profile;
a receiver to receive the request from the employer in response to the profile matching criteria specified by the employer; and
a transceiver to send a notification to the employer that the request has been accepted by the employee in response to the employee inputting on the input device that the request has been accepted.

4. A method of providing employees to an employer, the method comprising:
storing selectable profiles of employees;
accessing at least one of the selectable stored profiles based on criteria specified by an employer;
transmitting a request to the at least one employee corresponding to the at least one selectable profile in response to the employer selecting the at least one selectable profile; and
receiving a notification indicating that the at least one of the employees has accepted the request.
